(19) United States
(12) Patent Application Publication
(10) Pub. No.: US 2016/0099559 A1
(43) Pub. Date: Apr. 7, 2016

(54) OVERCURRENT PROTECTION FOR AN AUTOMOTIVE INSTRUMENT CLUSTER

(71) Applicant: Continental Automotive Systems, Inc., Auburn Hills, MI (US)

(72) Inventor: Manuel Fernandez-Guerrero, Tlaquepaque (MX)

(21) Appl. No.: 14/504,023

(22) Filed: Oct. 1, 2014

(51) Int. Cl. H02H 3/08; H02H 1/00

(52) U.S. Cl. CPC H02H 3/08; H02H 1/003

(57) ABSTRACT

A system and method for protecting an instrument panel circuit from overcurrents includes a differential amplifier that magnifies a voltage drop across at least one power input component. The magnified voltage drop is provided to a hysteresis comparator that compares the voltage drop against a pair of hysteresis thresholds. When the voltage drop exceeds the thresholds, an overcurrent is detected and a default state of a power switching element is changed from closed to open.

### TECHNICAL FIELD

The present disclosure relates generally to automotive instrument cluster circuits, and more specifically an overcurrent protection circuit for a instrument cluster printed circuit board.

### BACKGROUND

Automobiles, such as those used for commercial and personal use, include instrument clusters that convey necessary and optional information to a vehicle operator during operation of the automobile. By way of example, vehicle instrument clusters can display a fuel gauge, engine RPM's, radio station information, or any other similar information.

In order to facilitate the operation of the instrument cluster, a printed circuit board is typically included within the instrument cluster. The printed circuit board controls the operation of one or more gauges and indicators in the instrument cluster. Power is provided to the printed circuit from a power source, such as a battery, via a switched power connection. In some examples, the switch used to provide the connection is a Field Effect Transistor (FET). In alternative examples, the switched connection can be provided by other types of switches or switching networks. The switched power is provided through the printed circuit board via multiple printed connections, referred to as traces.

Due to the nature of the power source, any excess current caused by a short circuit, a poor quality printed circuit board, or any other feature, dissipates in the longest traces of the printed circuit board and overheating at the trace where the power is dissipating can occur. When a trace overheats, the trace can be damaged or destroyed, or nearby electrical components on the printed circuit board can be damaged or destroyed.

In order to prevent overheating form occurring, some existing printed circuit boards have employed one of two methods. First, some existing printed circuit boards have attempted to place the power distribution zone (e.g. the longest traces) as close to the connector as possible, thereby ensuring that other components are not damaged in a thermal event. Second, fuses have been incorporated to deactivate the switching FET controlling the power connection in the case of an overcurrent. As is understood in the art, when a fuse is exposed to an overcurrent, the fuse physically destructs, thereby breaking the circuit and preventing the overcurrent from promulgating. Utilization of fuses, however, requires that the fuse or the printed circuit board incorporating the fuse be replaced after each overcurrent event, increasing the frequency and cost of maintenance.

### SUMMARY OF THE INVENTION

In one example, an instrument panel circuit includes a power source, at least one control input component connecting the power source to a load, a switch element interruptibly connected between the at least one control input component and the load such that the control input is connected to the load when the switch element is closed and disconnected from the load when the switch element is open, an overcurrent protection circuit having a first voltage input connected to a high side of the at least one control input component and a second voltage input connected to a low side of the at least one control input, a pull up module connecting a gate and a source of the switch element, and an output of the overcurrent protection circuit is connected to a second switching element, and wherein the second switching element is configured such that a pull up module is switched out of the instrument panel circuit when the second switching element is closed and the pull up module is not switched out of the instrument panel circuit when the second switching element is open.

In another example, a method for providing overcurrent protection to a printed circuit includes detecting a voltage drop across at least one power input component, magnifying the voltage drop, and comparing the magnified voltage drop against at least a first threshold, changing a default state of a power switch from default close to default open when the magnified voltage drop exceeds the first threshold.

These and other features of the present invention can be best understood from the following specification and drawings, the following of which is a brief description.

### BRIEF DESCRIPTION OF THE DRAWINGS

FIG. 1 schematically illustrates a vehicle according to one embodiment of the invention.

FIG. 2 schematically illustrates a printed circuit board connected to a switched power source.

FIG. 3 schematically illustrates a detailed example overcurrent prevention circuit for use in the illustrated example of FIG. 2.

FIG. 4 illustrates a flowchart demonstrating an overcurrent protection method for a printed circuit board.

### DETAILED DESCRIPTION OF AN EMBODIMENT

FIG. 1 schematically illustrates a vehicle 10 including an instrument cluster 20. The instrument cluster 20 includes a printed circuit board 30 having circuitry for powering and controlling at least some informational elements displayed by the instrument cluster 20. The instrument cluster 20 is further connected to multiple sensors 40 distributed throughout the vehicle 10. Information from the sensors 40 is received and interpreted by the instrument cluster 20 and displayed for a driver to view. In some examples, the instrument cluster 20 is controlled by a microprocessor 22, or a general vehicle controller. The microprocessor 22 interprets the signals from the sensors 40 and provides the appropriate control signals to the printed circuit board 30.

The printed circuit board 30 is also connected to a power source 50, such as a vehicle battery. The printed circuit board 30 includes switches within the circuitry that enable the power source 50 to be connected and disconnected from the printed circuit board 30 as needed.

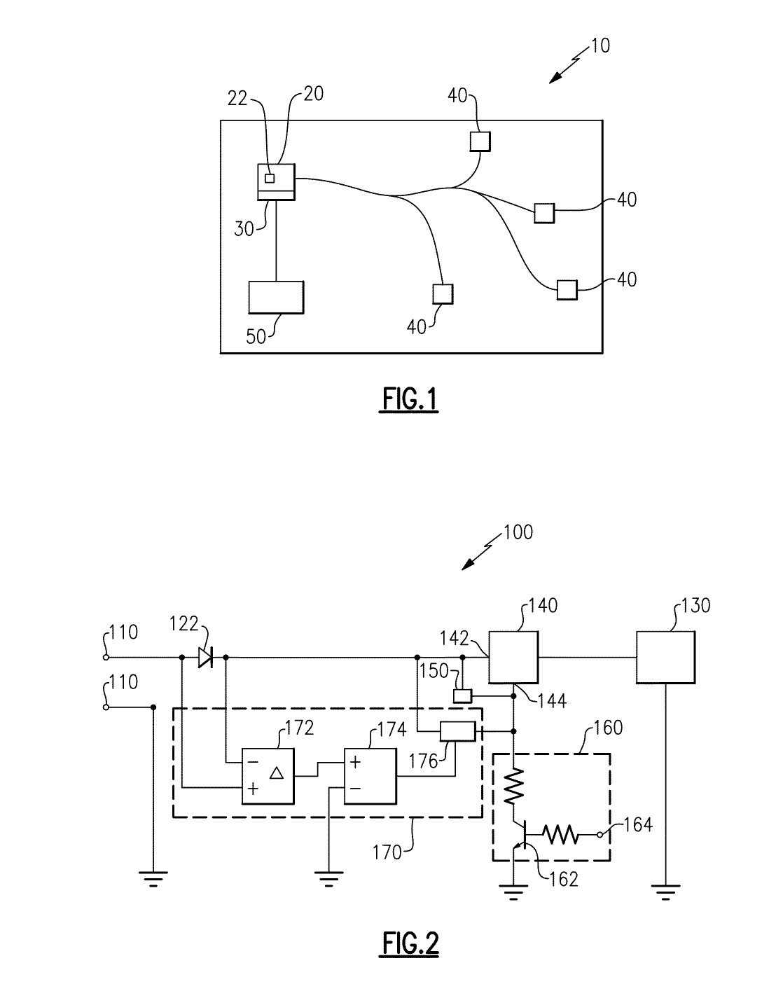

When an overcurrent occurs in the printed circuit board 30, due to a short circuit, an excess load, or for any other reason, overheating conditions can occur at or around the traces on the printed circuit board 30. In order to prevent damage resulting from these overcurrents, the printed circuit board 30 includes an overcurrent protection circuit (illustrated in FIG. 2) that is capable of detecting an overcurrent or conditions leading to an overcurrent and disconnecting the power source 50 from the printed circuit board 30 without permanently destroying, or altering, a component of the printed circuit board 30.

With continued reference to FIG. 1, and with like numerals indicating like elements, FIG. 2 schematically illustrates an overcurrent protection circuit 100 for a printed circuit board, such as the printed circuit board 30 illustrated in FIG. 1. The overcurrent protection circuit 100 includes multiple inputs 110, for connecting the positive and negative terminals of a power source to the overcurrent protection circuit 100. Each of the terminals 110 is connected through a power input component 122. In the illustrated example the power input component 122 is a single diode. In alternative examples, the power input component 122 can be a network of diodes at each terminal, or other electrical components that provide the same function.

The power input component 122 connects the power input terminals 110 to a power switch 140 that switchably connects the power source to a load 130. In the illustrated example, the load 130 is the circuit elements and components on the printed circuit board that are powered by the power source. A pull up circuit 150 ensures that power switch 140 is turned off when a signal in control switch 160 is not present. A control switch 160 includes a transistor 162 that is controlled by a microprocessor input 164. In alternative examples the microprocessor input 164 can receive an input from any other type of controller, and is not limited to microprocessor controls.

When the controller determines that the power to the load 130 should be switched on, the microprocessor turns the transistor 162 on. When the transistor 162 is turned off, a disconnection between the gate node 144 and ground, or neutral, is formed, thereby turning the power switch 140 off and preventing power from reaching the load 130.

During an overcurrent condition, the microprocessor, or other controller, can be too slow to react or may not include overcurrent detection software. In such a situation, damage can occur to the circuitry of the printed circuit board, and particularly in the load 130 portion of the printed circuit board. In order to prevent such an occurrence, the printed circuit board includes an overcurrent protection circuit 170. When the overcurrent protection circuit 170 detects an overcurrent, or a condition that leads to an overcurrent, a switch element 176 in the overcurrent protection circuit 170 is switched on. Due to the configuration of the overcurrent protection circuit 170, switching on the overcurrent protection switch element 176 effectively bypasses the pull up circuitry 150 from the circuit and connects the gate and the source nodes of power switch 140, causing the switching circuit 140 to remain off regardless of the control signal received at the microprocessor control input 164. In this way, the overcurrent protection circuit 170 is able to repeatedly provide overcurrent protection functions to the printed circuit board without destroying or damaging a component, as would occur in a fused protection.

The overcurrent protection circuit 170 includes a differential amplifier 172 and a hysteresis comparator 174. The differential amplifier 172 includes a positive input connected to a high voltage side of a power input component 122, and a negative input connected to a low voltage side of the power input component 122. While illustrated herein as being connected across a single power input component 122, one of skill in the art having the benefit of this disclosure will understand that the differential amplifier 172 can be connected across multiple power input components 122 within a single branch of the power input for the printed circuit board.

The differential amplifier detects the voltage drop across the power input component 122, and amplifies the magnitude of the voltage drop by a predetermined gain. The voltage drop across the power input component 122 directly corresponds to the magnitude of current entering the printed circuit board, with an increasing voltage drop corresponding to an increasing current. The magnitude of the voltage drop across the power input component is relatively small, even during overcurrent conditions. As a result, absent magnification, overcurrents can be difficult to distinguish from ordinary high currents. The differential amplifier 172 magnifies the voltage drop to a useable magnitude.

The differential amplifier 172 outputs a signal indicative of the magnified voltage drop to a positive input of a hysteresis comparator 174. The hysteresis comparator 174 includes a negative input that is connected to ground. A standard comparator compares two input values and outputs high (outputs a voltage signal) when the difference between the two values exceeds a preset threshold. The level of the threshold can be set by one of skill in the art using any known comparator threshold technique.

A hysteresis comparator, such as the hysteresis comparator 174 included in the overcurrent protection circuit 170, includes a positive feedback line connecting the output of the hysteresis comparator 174 to the positive input terminal of the hysteresis comparator 174. The positive input feedback introduces hysteresis into the comparison resulting in the illustrated hysteresis comparator 174. During practical operation, the hysteresis comparator 174 switches from a low (zero voltage) output to a high (positive voltage) output when a first threshold is exceeded. The first threshold is referred to as a high threshold. Once the hysteresis comparator 174 has switched to a high output, the hysteresis comparator switches back to a low output when the difference between the positive input of the hysteresis comparator 174 and the reference voltage falls below a second threshold. The second threshold is referred to as a low threshold and is a lower value than the high threshold. The magnitude of the difference between the high threshold and the low threshold is controlled by tuning the electrical components in the feedback path according to known principles.

The output of the hysteresis comparator 174 is provided to the switching element 176. The switching element 176 is turned on when the output of the hysteresis comparator 174 is high, and off when the output of the hysteresis comparator 174 is low. The switching element 176 places a switch component in the power switch 140 in a gate-source union state when the switching element 176 is on, thereby preventing the power switch 140 from turning on, regardless of the input from the microprocessor input 164.

Under the above arrangement, the differential amplifier 172 combined with the hysteresis comparator 174 determine when an overcurrent is occurring and turn off the power supply switch 140, thereby protecting the printed circuit without damaging or destroying any components of the printed circuit board. By including hysteresis in the hysteresis comparator 174, unstable oscillations in the output of the hysteresis comparator 174 are prevented. Preventing unstable oscillations also prevents the overcurrent protection device from switching on and off in rapid succession.

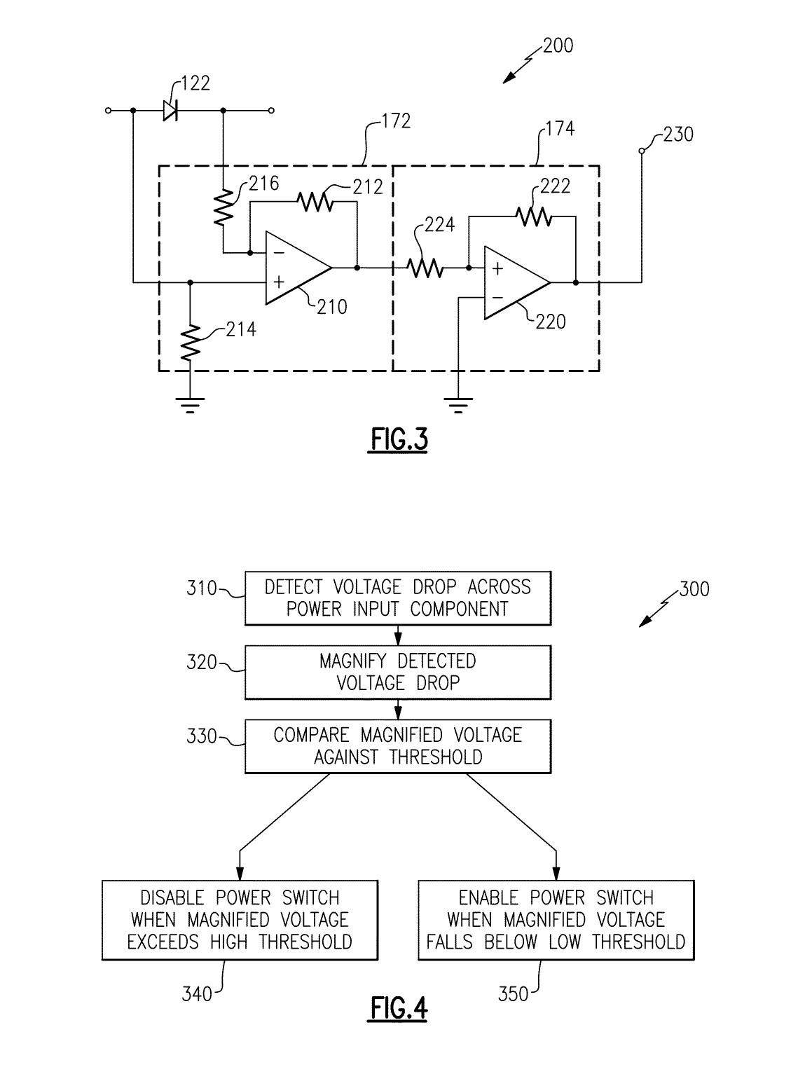

By way of further, non-limiting, example, and with like numbers indicating like elements, FIG. 3 illustrates an example circuit design for implementing the above described differential amplifier 172 and the above described hysteresis comparator 174.

In the illustrated example, the differential amplifier 172 is an operational amplifier 210 (alternatively referred to as an op-amp) configured in a differential comparator mode. A feedback path connects an output of the operational amplifier 210 to the negative pin input of the operational amplifier 210. Connected within the feedback path is a resistor 212. Similarly, a resistor 214 is connected at the positive terminal of the operational amplifier 210 and a resistor 216 is connected at the negative terminal of the operational amplifier 210. The relative values of the resistors 212, 214 and 216 determine the amount by which the voltage differential between the input voltage at the positive terminal and the negative terminal is magnified. The factor of magnification is referred to as the gain of the differential amplifier 172. The output of the operational amplifier 210 is a voltage corresponding to the difference in input voltages multiplied by the gain, minus any efficiency losses.

In practical circuits, the voltage drop across the power input component 122 is minimal, even in overcurrent conditions. As a result, distinction between an overcurrent event and a normal high current condition is difficult. By amplifying the voltage differential the difference between the overcurrent condition and the normal high current condition is magnified, and the distinction becomes clearer.

The magnified voltage differential is then provided to a positive input terminal 224 of a hysteresis comparator 174. The example hysteresis comparator 174 is an operational amplifier 220 based hysteresis comparator 174, including a positive input receiving the output of the differential amplifier 220, and a negative input terminal tied to ground, or neutral. The hysteresis is provided via the feedback path connecting the output of the operational amplifier 220 to the positive terminal input. The magnitude of the hysteresis is controlled by the relative resistances of a feedback resistor 222 and an input resistor 224. The magnitude of the hysteresis determines how far apart the high threshold and the low threshold of the hysteresis comparator are, and can be controlled by one of skill in the art having the benefit of this disclosure according to known principles. The output of the hysteresis comparator is then provided to the overcurrent protection switching element 176 via an output terminal 230.

While described and illustrated above as operational amplifier components, one of skill in the art, having the benefit of this disclosure, will understand that alternative differential amplifier constructions, and alternative hysteresis comparator constructions can be utilized with minor modifications being made to the circuit of FIG. 3, and still fall within the above described disclosure.

With continued reference to FIG. 1-3, FIG. 4 illustrates a flowchart demonstrating an overcurrent protection method 300 enabled by the above described overcurrent protection circuit. Initially, an overcurrent protection circuit detects a voltage drop across a power input component in a “Detect Voltage Drop Across Power Input Component” step 310. As described above, the detected voltage is too small to distinguish between an overcurrent and an expected high current. In order to make the necessary determinations, the detected voltage drop is then magnified in a “Magnify Detected Voltage Drop” step 320 using a differential amplifier.

The magnified voltage is then compared against multiple thresholds using a hysteresis comparator in a “Compare Magnified Voltage Against Thresholds” step 330. When the determined voltage drop exceeds a high threshold of the hysteresis comparator, an overcurrent is detected, and a connection to the power source is switched off in a “Disable Power Switch When Magnified Voltage Exceeds High Threshold” step 340. Once the output of the hysteresis comparator becomes high, the comparator output remains high until the magnified voltage falls below a low threshold. Once the magnified voltage falls below the low threshold, the power supply is reconnected and normal operations are resumed in an “Enable Power Switch When Magnified Voltage Falls Below Low Threshold” step 350.

While described above with reference to a printed circuit board, one of skill in the art, having the benefit of this disclosure, will understand that the printed circuit board can include additional components, such as resistors, capacitors, transistors, and the like, mounted to the printed circuit board. Further, one of skill in the art, having the benefit of this disclosure will recognize that the printed circuit board can be replaced in some examples with a traditional circuit with only minor modifications, and still fall within the above disclosure.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

1. An instrument panel circuit comprising:
a power source;
at least one control input component connecting said power source to a load;
a switch element interruptibly connected between said at least one control input component and said load such that said control input is connected to said load when said switch element is closed and disconnected from said load when said switch element is open;
an overcurrent protection circuit having a first voltage input connected to a high side of said at least one control input component and a second voltage input connected to a low side of said at least one control input;
a pull up module connecting a gate and a source of said switch element; and
an output of the overcurrent protection circuit is connected to a second switching element, and wherein the second switching element is configured such that a pull up module is switched out of the instrument panel circuit when the second switching element is closed and the pull up module is not switched out of the instrument panel circuit when the second switching element is open.

2. The instrument panel circuit of claim 1, wherein the overcurrent protection circuit includes a differential amplifier and a hysteresis comparator.

3. The instrument panel circuit of claim 2, wherein the differential amplifier includes a positive input and a negative input, and wherein the differential amplifier is configure to amplify a voltage drop across said at least one control input component.

4. The instrument panel circuit of claim 2, wherein the hysteresis comparator includes a positive input connected to an output of the differential amplifier, and a negative input connected to one of a reference voltage and a ground.

5. The instrument panel circuit of claim 2, wherein an output of the hysteresis comparator is a control input for the second switching element.

6. The instrument panel circuit of claim 5, wherein the second switching element is a transistor, and wherein the second switching element is connected parallel to said pull up component.

7. The instrument panel circuit of claim 1, further comprising a controller input connected to a gate of said switching element, wherein said controller input is operable to control an open/close state of said switching element.

8. The instrument panel circuit of claim 7, wherein said controller input further includes a transistor connecting a gate of said switching element to a ground, wherein a control input of said transistor is a terminal for connecting to an external controller, and wherein said switching element is in a default state when no input is received from said external controller, and said switching element is in an open state when a high signal is received from said external controller.

9. The instrument panel of claim 8, wherein said default state of said switching element is a closed state when no overcurrent is detected by said overcurrent protection device and said default state of said switching element is an open state when an overcurrent is detected by said overcurrent protection device.

10. The instrument panel of claim 2, wherein said differential amplifier is in operational amplifier based differential amplifier and said hysteresis comparator is an operational amplifier based hysteresis comparator.

11. A method for providing overcurrent protection to a printed circuit comprising:
detecting a voltage drop across at least one power input component;
magnifying the voltage drop, and comparing the magnified voltage drop against at least a first threshold;
changing a default state of a power switch from default close to default open when the magnified voltage drop exceeds the first threshold.

12. The method of claim 11, wherein detecting a voltage drop across at least one power input component comprising connecting a positive input of a differential amplifier to a high voltage side of the at least one power input component and connecting a negative input of the differential amplifier to a low voltage side of the at least one power input component.

13. The method of claim 11, wherein comparing the magnified voltage drop against at least a first threshold comprises providing the magnified voltage drop to a positive input of a hysteresis comparator, and providing a reference voltage to a negative input of the hysteresis comparator.

14. The method of claim 13, wherein the reference voltage is a neutral.

15. The method of claim 11, wherein changing a default state of a power switch from default close to default open when the magnified voltage drop exceeds the first threshold comprises providing a short circuit path around a pull up component when an overcurrent is detected, thereby bypassing the pull up component from the circuit.

16. The method of claim 15, wherein electrically bypassing the pull up component causes the default state of a power switching element to be an open state.

17. The method of claim 11, wherein comparing the magnified voltage drop against at least a first threshold is performed using a hysteresis comparator and the application of hysteresis ensures stability of the overcurrent detection.

18. The method of claim 11, wherein changing a default state of a power switch from default close to default open when the magnified voltage drop exceeds the first threshold provides a non-destructive change to a circuit containing said power switch.
